(19) United States
(12) Patent Application Publication
(10) Pub. No.: US 2015/0088600 A1
(43) Pub. Date: Mar. 26, 2015

(54) BUSINESS NETWORK MAPPING

(71) Applicant: Go Daddy Operating Company, LLC, Scottsdale, AZ (US)

(72) Inventors: John Pysher, Chandler, AZ (US); Amold Blinn, Hunts Point, WA (US)

(73) Assignee: Go Daddy Operating Company, LLC, Scottsdale, AZ (US)

(21) Appl. No.: 14/036,910

(22) Filed: Sep. 25, 2013

(51) Int. Cl. G06Q 30/02

(52) U.S. Cl. CPC G06Q 30/0201
USPC 705/7.29

(57) ABSTRACT

A method is described for determining a business network for a plurality of websites engaged in commerce and a plurality of end users, i.e., customers of the websites engaged in commerce. A network mapping entity and/or other websites, such as one or more of the plurality of websites engaged in commerce, may store a customized tracking cookie on each computer of a plurality of visitors to the network mapping entity or the websites engaged in commerce. If the visitors are also customers of the network mapping entity, the network mapping entity may store the customers' login information, tracking cookies, and/or other visitor's data as desired. The plurality of websites engaged in commerce may have a tracking code on them. The tracking code allows the websites engaged in commerce to collect additional information about the visitors/customers (now referred to as end users) and communicate the additional information, i.e. end users data, to the network mapping entity. The network mapping entity may use all of the collected information to determine a business network for the plurality of visitors, customers and/or end users in relation to the plurality of websites engaged in commerce.

### FIELD OF THE INVENTION

The present invention generally relates to determining a business network for websites engaged in commerce and a plurality of end users that are customers of one or more of the websites.

### SUMMARY OF THE INVENTION

In an embodiment of the invention, a method is disclosed for determining a business network related to a plurality of websites engaged in commerce and a plurality of end users that are customers of one or more of the websites. The websites engaged in commerce are preferably hosted by a network mapping entity. The network mapping entity may receive a plurality of end user data related to the plurality of end users from the plurality of websites. Each of the plurality of websites preferably includes a tracking code that allows the plurality of websites to collect end user data and transmit the end user data to the network mapping entity. The network mapping entity may then determine a business network for the plurality of websites and the plurality of end users using the end user data collected by the plurality of websites. In addition, visitor and customer data may be collected by the network mapping entity when visitors and/or customers access or log into the network mapping entity's website. The visitor and customer data may also be used, in combination with the end user data, to determine a business network. The determined business network may then be used for marketing, such as by targeted marketing.

In another embodiment, a method is disclosed for determining a business network for a plurality of websites and a plurality of end users. In this embodiment, a network mapping entity (through its front of site, control panels, applications, servers, or websites it directly or indirectly controls) or a tracking cookie distributing website (which may be hosted by the network mapping entity) may distribute or download a tracking cookie to one or more visitor. The network mapping entity may receive data from the visitor if the visitor accesses or logs into (if the visitor logs into the network mapping entity then the visitor may also be considered a customer) the network mapping entity's website. The network mapping entity may store the data from the visitor in a tracking cookie database. The network mapping entity (or other entities working with the network mapping entity such as a tracking code distributing website) may distribute a tracking code to one or more websites engaged in commerce, where the program may be stored and executed. Visitors to the network mapping entity may at some subsequent point access one or more of the websites engaged in commerce (in which case the visitors are now also known as end users) where the websites engaged in commerce may collect end user data (data related to the end user, the end user's computer, or data related to the session). The network mapping entity may receive (for example, by either pushing or pulling) the end user data from the websites engaged in commerce. The network mapping entity may store the end user data in an end user database. The network mapping entity may determine a business network for the end user(s) and the websites using the end user database. Alternatively, the data in the tracking cookie database may also be used, in combination with the end user data, to produce an enhanced or more thorough business network.

In another embodiment of the invention, a method for determining a business network for a plurality of visitors and a plurality of websites engaged in commerce is disclosed. In this embodiment, a network mapping entity (through its front of site, control panels, applications, servers, or websites it directly or indirectly controls) or a tracking cookie distributing website (which may be hosted by the network mapping entity) may distribute or download a tracking cookie to one or more of the plurality of visitors. If a visitor accesses or logs into the network mapping entity, the network mapping entity may collect data regarding the visitor and the tracking cookie. The network mapping entity may store the collected data and/or tracking cookie in a tracking cookie database. The network mapping entity or a tracking code distributing website (which may be hosted by the network mapping entity) may distribute a tracking code to the one or more websites engaged in commerce. The network mapping entity may receive an end user data and tracking cookies from the one or more websites engaged in commerce. The network mapping entity may store the end user data and the tracking cookies in an end user database. The network mapping entity may periodically compare the login data and the tracking cookies in the tracking cookie database with the end user data and the tracking cookies in the end user database. If a tracking cookie in the login data matches a tracking cookie in the end user database, the network mapping entity may store a plurality of network mapping data in a network mapping database. The network mapping entity, using the network mapping database, may determine a business network for the plurality of visitors and the plurality of websites engaged in commerce. This method of determining a business network may be applied to any number of one or more visitors, customers and/or end users and their business relationships with any number of one or more websites engaged in commerce.

The above features and advantages of the present inventions will be better understood from the following detailed description taken in conjunction with the accompanying drawings.

### BRIEF DESCRIPTION OF THE DRAWINGS

FIG. 1 illustrates a possible embodiment of a system for determining a business network for a plurality of end users and a plurality of websites engaged in commerce.

FIG. 2 is a flow diagram illustrating a possible embodiment of a method for determining a business network for a plurality of visitors and a plurality of websites engaged in commerce.

FIG. 3 is a flow diagram illustrating a possible embodiment of a method for determining a business network for a plurality of visitors and a plurality of websites engaged in commerce.

FIG. 4 is a flow diagram illustrating a possible embodiment of a method for determining a business network for a plurality of end users and a plurality of websites engaged in commerce.

### DETAILED DESCRIPTION

The present inventions will now be discussed in detail with regard to the attached drawing figures, which were briefly described above. In the following description, numerous specific details are set forth illustrating the Applicant's best mode for practicing the inventions and enabling one of ordinary skill in the art to make and use the inventions. It will be obvious, however, to one skilled in the art that the present inventions may be practiced without many of these specific details. In other instances, well-known machines, structures, methods and processes have not been described in particular detail in order to avoid unnecessarily obscuring the present inventions. Unless otherwise indicated, like parts and method steps are referred to with like reference numerals.

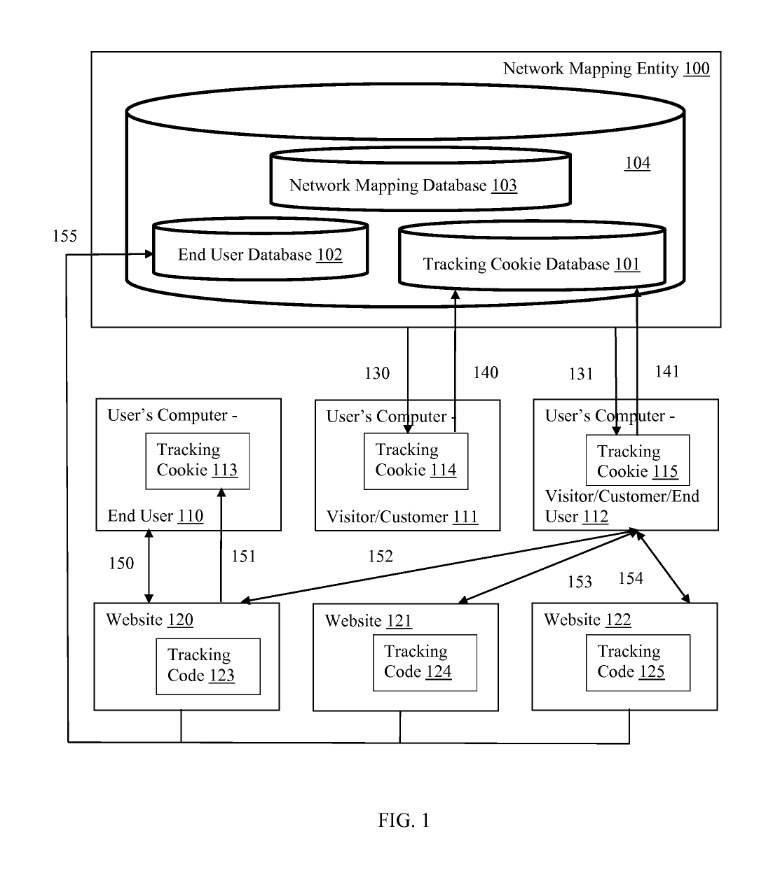

A network is a collection of links (communication paths) and nodes (e.g., multiple computers and/or other devices connected together) arranged so that information may be passed from one part of the network to another part of the network over multiple links and through various nodes. Thus, in FIG. 1, links 130, 131, 140, 141, 150, 151, 152, 153, 154, and 155 are communication paths, following communication protocols and technologies, now known and/or developed in the future, in one or more networks. Examples of networks include the Internet, the public switched telephone network, the global Telex network, computer networks (e.g., an intranet, an extranet, a local-area network, or a wide-area network), wired networks, wireless networks, and hybrid networks. A network may be owned and operated by one or more companies, partnerships, and/or individuals.

The Internet is a worldwide network of computers and computer networks arranged to allow for the easy and robust exchange of information between computer users, such as end user 110, visitor/customer 111, and visitor/customer/end user 112 and content provider websites 120, 121, 122, which may be business websites that offer goods and/or services for sale, i.e., engaged in commerce. Hundreds of millions of people around the world have access to computers connected to the Internet via Internet Service Providers (ISPs).

The network mapping entity 100, end user 110, visitor/customer 111, visitor/customer/end user 112, and websites 120, 121, 122 may comprise one or more computers or computer servers and be communicatively coupled to the network links 130, 131, 140, 141, 150, 151, 152, 153, 154, 155 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof. As non-limiting examples, the servers could be application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, cloud computing, grid computing or any combination thereof).

The network mapping entity 100 and websites 120, 121, 122 may comprise any collection of data and/or files accessible to a client or server communicatively coupled to the network links 130, 131, 140, 141, 150, 151, 152, 153, 154, and 155. As a non-limiting example, the website(s) may comprise a single webpage or multiple interconnected and related webpages resolving from a domain name, each of which may provide access to static, dynamic, multimedia, or any other content, perhaps by accessing files (e.g., text, audio, video, graphics, executable, HTML, eXtensible Markup Language (XML), Active Server Pages (ASP), Hypertext Preprocessor (PHP), Flash files, server-side scripting, etc.) that enable the website(s) to display when rendered by a client or the user's computer's 110, 111, 112 browser.

The term “visitor” may be used herein for brevity, but visitor should be understood to mean, in the specification and the claims, as a user's computer, client or server that is used to access (visit) the network mapping entity 100 over a network, such as the Internet.

The term “customer” may be used herein for brevity, but customer should be understood to mean, in the specification and the claims, as a user's computer, client, or server that is used to login to, purchase goods and/or purchase or use services from the network mapping entity 100 and/or the websites 120, 121, 122 over a network, such as the Internet.

The term “end user” may also be used herein for brevity, but end user should be understood to mean, in the specification and the claims, as a user's computer, client, or server that is used to access, typically using a browser on the Internet, a plurality of websites 120, 121, 122 engaged in commerce. It should be noted from the definitions that a user's computer, client, or server may be a visitor, customer, end user, or any combination thereof. An end user 110, visitor/customer 111, and visitor/customer/end user 112 are illustrated as non-limiting examples in FIG. 1 and may be referenced herein simply as a user's computer 110, 111, 112.

Content providers (e.g., website owners or operators) place multimedia information (e.g., text, graphics, audio, video, animation, and other forms of data) at specific locations on the Internet shown in FIG. 1 as websites 120, 121, 122. Websites 120, 121, 122 comprise a collection of connected or otherwise related webpages. The combination of all the websites and their corresponding webpages on the Internet is generally known as the World Wide Web (WWW) or simply the Web. Network servers and other hardware and software may be used to support websites that reside on the Web. Websites 120, 121, 122 are preferably hosted by the network mapping entity 100.

In addition to providing content, websites 120, 121, 122 may be configured to offer products and/or services for use or sale, i.e., engage in commerce. Websites 120, 121, 122 may be contact points for end user 110 or visitor/customer/end user 112 to access and conduct business with the owners of the websites 120, 121, 122. In the specific example illustrated in FIG. 1, end user 110 may create a business relationship with website 120 via link 150 and visitor/customer/end user 112 may create business relationships with websites 120, 121, 122 via links 152, 153, 154 respectively.

The present invention is not limited by any particular number of end users 110, 112 websites 120, 121, 122 or business relationships between end users 110, 112 and websites 120, 121, 122. The pattern of business relationships between all the end users 110, 112 and all the websites 120, 121, 122 (and possibly the network mapping entity 100 itself) is referred to as a business network. These business networks often represent groups of businesses that interact and consume each other's offered services.

In practice, there may be thousands, millions or more end users 110, 112, websites 120, 121, 122, and created business relationships, thereby forming a very large and complicated business network. In addition, the business network may constantly change as end users 110, 112 visit different websites 120, 121, 122 and new end users and websites are added over time. Old business relationships may also be removed from the databases, and therefor from consideration when determining a business network, after a predetermined period of time.

Further, the business network of business relationships between end users 110, 112 and websites 120, 121, 122 will typically not be random, but will tend to display patterns that may be used for targeted marketing or aftermarket data sales. The network mapping entity may use a machine learning algorithm to parse through all the data to discover the various patterns and groupings to discover one or more business networks.

As non-limiting examples, the machine learning algorithm used to discover one or more business networks may be a supervised learning, unsupervised learning, semi-supervised learning, transduction, transductive inference, reinforcement learning, learning to learn, developmental learning, decision tree learning, association rule learning, artificial neural network, inductive logic programming, support vector machine, clustering, Bayesian network, reinforcement learning, representation learning, similarity and metric learning, sparse dictionary learning, and/or other machine learning algorithms/techniques currently known or developed in the future.

For example, it may be discovered through examination of the determined business network that end users (for example visitor/customer/end user 112) that visit a particular website (for example website 120) often visit one or more other website(s) (for example websites 121, 122). Thus, if end user 110 is discovered to have visited website 120, but has not visited the other websites 121, 122, then end user 120 may be targeted for marketing by the non-visited websites 121, 122. This highly targeted form of marketing is expected to be much more effective than traditional “shot-gun” methods employed in the past.

Targeted marketing may be performed by the network mapping entity 100, by websites 121, 122, or by other websites that collect the target marketing information from the network mapping entity 100. The targeted marketing may take the form of advertisements displayed to the end user 120 within the end user's browser (including pop-ups), advertisements emailed to the end user 120, or by any other method of advertisement.

The network mapping entity 100 may also use the discovered business network(s) to market products and/or services on behalf of the network mapping entity's customers. The network mapping entity 100 may rank customers based on how often the customers use services of either the network mapping entity 100 or other businesses 120, 121, 122 and target customers based on the customers' rank.

The network mapping entity 100 may also identify communities within the business network that perform similar functions and/or offer similar services. This may allow the network mapping entity 100 to target customers of related businesses 120, 121, 122. For example, if a business 120 sells athletic shoes, then that business's 120 customers could be targeted by another business 121 that sells sporting equipment. This could help the business 121 that sells sporting equipment because people who buy athletic shoes are more likely than the general population to be interested in sporting equipment.

The network mapping entity 100 may also identify one or more influencers within a community or within a business network. These influencers, through their social media, sphere of influence, personal contacts or other methods, are able to influence the purchasing activities of other consumers to a greater extent than a typical person or customer. Thus, it is advantageous to market to the one or more influencers as they have the potential to bring additional customers to a business 120, 121, 122.

The network mapping entity 100 may also bring together different businesses that may be able to cooperate with each other to create synergies. As non-limiting examples, the businesses may use each other's services or even refer customers to each other if the referred business would be better at serving a particular customer.

The above described marketing capabilities may be used to enhance one or more of the websites 120, 121, 122 engaged in commerce. In preferred embodiments, combinations of the marketing capabilities may be used to enhance a website's 120, 121, 122 business.

The network mapping entity 100 may comprise one or more network servers, routers, Internet connections, software, and databases and be used to determine the above described business network and coordinate the use of the discovered business network. While the network mapping entity 100 may specialize in discovering business networks, the network mapping entity 100 is preferably an Internet business that has significant contacts with Internet users, such as visitor/customer 111 and visitor/customer/end user 112 via links 130, 131, 140, 141 and business websites, such as website 120, 121, 122 via link 155. The network mapping entity 100 is preferably an entity that provides hosting services to websites 120, 121, 122 engaged in commerce.

The network mapping entity 100 may include a database 104. The database 104 may, itself, comprise one or more databases 101, 102, 103. Databases 101, 102, 103, 104 may be structured as arrays, lists, spreadsheets, relational database or any other format and may be centralized, distributed or structured as a hybrid or in any other manner now known or developed in the future. As a non-limiting example, FIG. 1 illustrates that database 104 comprises a tracking cookie database 101, an end user database 102, and a network mapping database 103. While network mapping entity 100 does send, receive, store and recall data, the invention is not limited to any particular method or structure of storing or recalling data.

A tracking cookie 113, 114, 115 may be a cookie, an HTTP cookie, web cookie, or browser cookie and is a small piece of data sent from a website (such as network mapping entity 100 or website 120, 121, 122) and stored in a user's computer while the user is browsing a website. When the user (such as end user 110 or visitor/customer/end user 112) browses the same website in the future, the data stored in the tracking cookie 113, 114, 115 may be read by the website to notify the website of the user's previous activity.

Tracking cookies 113, 114, 115 are designed to be a reliable mechanism for websites to remember the state of the website, activity the user had taken in the past, or other data. This can include, as non-limiting examples, name of the tracking cookie, value of the tracking cookie, user's IP Address, user's browser, date user accessed the website, page(s) accessed by the user, user's operating system, user's shopper ID, user's name and/or login name, and/or any other data useful for determining the user's business relationships with a website.

Some of the data stored in a tracking cookie 113, 114, 115 IP, e.g., user's IP address, user's browser, date the user accessed the website, and user's operating system may be determined from an HTTP Header used in the communication between the user's computer and either the network mapping entity 100 or the website 120, 121, 122. Other data used in the tracking cookie 113, 114, 115, e.g., shopper ID, user name or login name, page(s) accessed by the user, may be determined by the network mapping entity 100 or various other website(s) 120, 121, 122 visited by the user 110, 111, 112. Still other data used in the tracking cookie 113, 114, 115, e.g., name of the tracking cookie 113, 114, 115, value of the tracking cookie 113, 114, 115 may be generated by the network mapping entity 100 or the websites 120, 121, 122. In addition, other data may be found in one or more databases on the Internet using the previously mentioned data. End user data refers to any data stored in a tracking cookie 113, 114, 115.

In a preferred embodiment, a tracking code 123, 124, 125 is installed on one or more websites 120, 121, 122 and possibly on the network mapping entity 100. The tracking code 123, 124, 125 may be communicated to and installed on website 120, 121, 122 via either the network mapping entity 100 (or any website(s) directly or indirectly controlled by the network mapping entity 100) or by other website(s) 120, 121, 122 (which may be hosted by the network mapping entity 100). In one embodiment, all websites 120, 121, 122 receiving the tracking code 123, 124, 125 are hosted by the network mapping entity 100, while in another embodiment, the tracking code 123, 124, 125 is installed on websites 120, 121, 122 that may or may not be hosted by the network mapping entity 100.

The tracking code 123, 124, 125 is software (preferably written in Javascript) that may be executed on websites 120, 121, 122. When a user's computer 110, 111, 112 communicates with the website 120, 121, 122, the tracking code 123, 124, 125 may try to read a tracking cookie 113, 114, 115 from the user's computer 110, 111, 112. If no tracking cookie 113, 114, 115 is found on the user's computer 110, 111, 112, a tracking cookie 113, 114, 115 may be stored on the user's computer 110, 111, 112. If a tracking cookie 113, 114, 115 is found on the user's computer 110, 111, 112, the tracking cookie 113, 114, 115 may be read and logged (stored) by the website 120, 121, 122 and then updated and resent to the user's computer 110, 111, 112 to reflect the current interaction between the user's computer 110, 111, 112 and the website 120, 121, 122.

In addition, if a tracking cookie 113, 114, 115 is found on the user's computer 110, 111, 112, the tracking code 123, 124, 125 on the websites 120, 121, 122 may read the tracking cookie 113, 114, 115 and log, as non-limiting examples, the name of the tracking cookie 113, 114, 115, the website's 120, 121, 122 domain name (or other identifying feature), the user's IP address, the user's browser, the date and/or time the user accessed the website 120, 121, 122, the user's operating system, the requested webpages' name(s), the HTTP status code, the size of the user's request, the referral source, the referral medium, and/or the referral keyword(s). Additional data may also be logged as desired and not all of the listed items have to be used in the tracking cookie 113, 114, 115 or logged by the website 120, 121, 122. All of the data related to the user and the user's computer's interaction and/or relationship with the website 120, 121, 122 may be referred to as the end user data.

The tracking code 123, 124, 125 running on the website 120, 121, 122 may communicate, as non-limiting examples, by either pushing or pulling the logged end user data at the website 120, 121, 122 to the network mapping entity 100. The communication may be done at specific predetermined times, periodically, when requested by the network mapping entity 100, when requested by the website 120, 121, 122, after the website 120, 121, 122 has collected a predetermined amount of end user data or by any other desired method. The network mapping entity 100 may store the end user data in end user database 102 via link 155.

Users may also visit and build a relationship with the network mapping entity 100. The user may either be a visitor or a customer of the network mapping entity 100. If the user is a customer and logs into the network mapping entity 100, additional data may be collected such as the login data, the user's shopper ID, purchase history, interactions with product(s) and/or other data already known by the network mapping entity 100 to be associated with that user/visitor/customer. Data from interactions between the user's computer 110, 111, 112 and the network mapping entity 100 may include the user's computer 110, 111, 112 IP addresses, time/date accessed, etc. This data may be stored in the tracking cookie database 101.

Data from either the end user database 102 (data collected in connection with the user's computers 110, 111, 112 visiting one or more websites 120, 121, 122 engaged in commerce) or the tracking cookie database 101 (data collected in connection with the user's computers 110, 111, 112 visiting the network mapping entity 100), or preferably from both databases, may be used by the network mapping entity 100 to create a business network for all of the user's computers 110, 111, 112, websites 120, 121, 122 and, optionally, the network mapping entity 100.

As one possible method of determining a business network, the end user data in the end user database 102 may be periodically compared with the visitor and customer data in the tracking cookie database 101. If the same user is discovered in both databases, such as by noting common unique data in both databases, the tracking cookie 113, 114, 115, the customer's domain name, the end user tracking cookie, date(s) and time(s) of visit(s), and webpages visited by the end user may be stored in a network mapping database 103. The data in the network mapping database 103 may then may be analyzed by a machine learning algorithm and used by the network mapping entity 100 to determine a business network for the end users 110, 112 and websites 120, 121, 122.

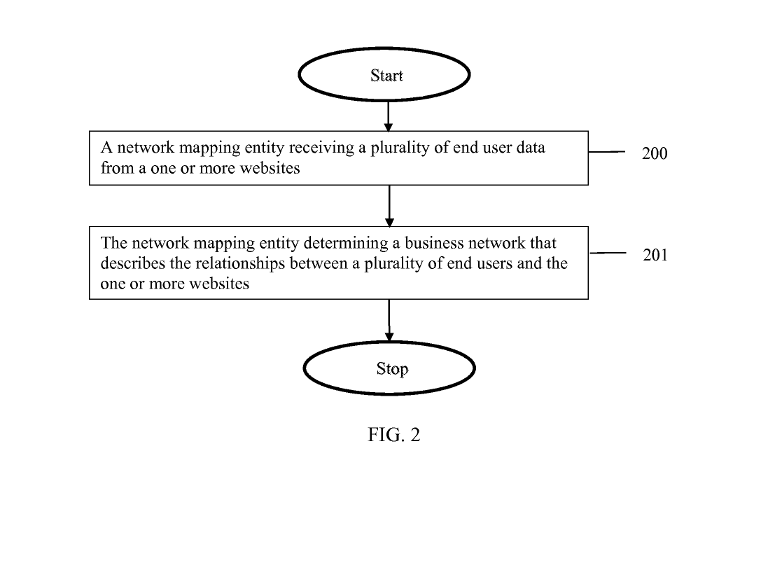

FIG. 2 will now be used to illustrate an exemplary embodiment of the invention. This method determines a business network for a plurality of end users 110, 112 and a plurality of websites 120, 121, 122 engaged in commerce. (Visit/customer 111 is not an end user because visitor/customer 111 does not have any links to, i.e. visitor/customer has not visited, a website 120, 121, 122 that includes a tracking code 123, 124, 125.)

A network mapping entity 100 may receive a plurality of end user data for the plurality of end users 110, 112 from the plurality of websites 120, 121, 122. (Step 200) Each of the plurality of websites 120, 121, 122 preferably includes a tracking code 123, 124, 125 that allows the plurality of websites 120, 121, 122 to collect end user data and transmit the end user data to the network mapping entity 100. The network mapping entity 100 may then determine a business network for the plurality of end users 110, 112 and the plurality of websites 120, 121, 122 engaged in commerce using the plurality of end user data. (Step 201) In a preferred embodiment, the network mapping entity 100 uses a machine learning algorithm to determine one or more business communities or one or more business networks in the plurality of websites 120, 121, 122.

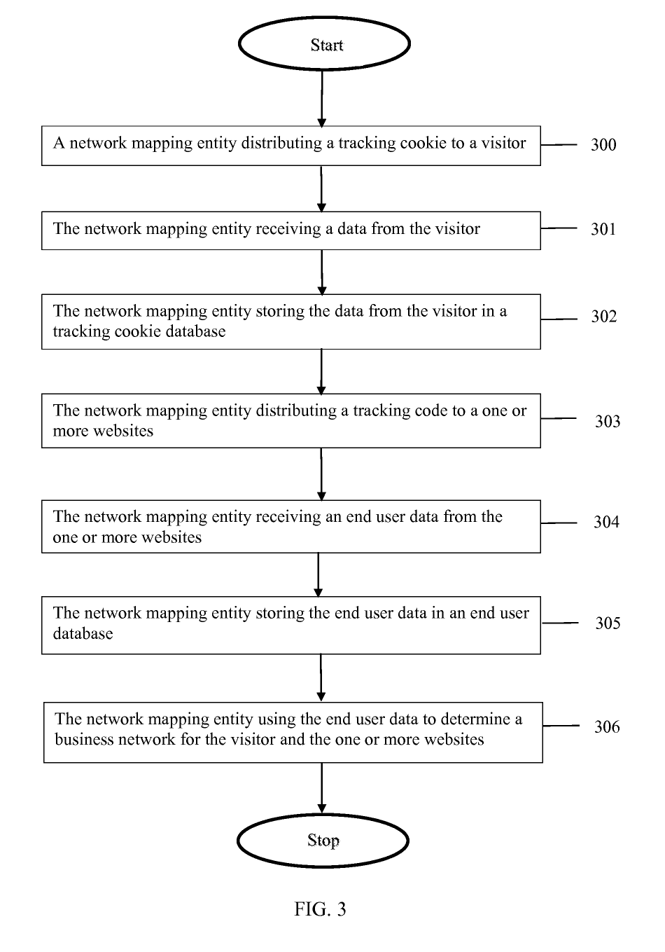

In another embodiment illustrated in FIG. 3, a method is disclosed for determining a business network for a plurality of end users 110, 112 and a plurality of websites 120, 1212, 122 engaged in commerce. In this embodiment, a network mapping entity 100 (directly or indirectly) or a tracking cookie distributing website distributes a tracking cookie to a visitor's computer 110, 111, 112. (Step 300) The network mapping entity 100 may receive a visitor, customer, and/or login data if the visitor logs into the network mapping entity's 100 website. (Step 301) The network mapping entity 100 may store the visitor, customer, and/or login data for the visitor in a tracking cookie database 101. (Step 302)

The network mapping entity 100 or a tracking code distributing website may distribute a tracking code 123, 123, 125 to a website 120, 121, 122 engaged in commerce where the tracking code (software program) may be stored and executed. (Step 303) The network mapping entity 100 may receive (for example, by either pushing or pulling) an end user data from the website 120, 121, 122. (Step 304) The network mapping entity 100 may store the end user data in an end user database 102. (Step 305)

Finally, the network mapping entity 100 may determine a business network for the visitor and the websites 120, 121, 122 using the end user database 102. (Step 306) In other embodiments, end user data from a plurality of visitors, customers and/or end users may be used to determine a business network for all of the plurality of visitors, customers and/or end users and the websites 120, 121, 122.

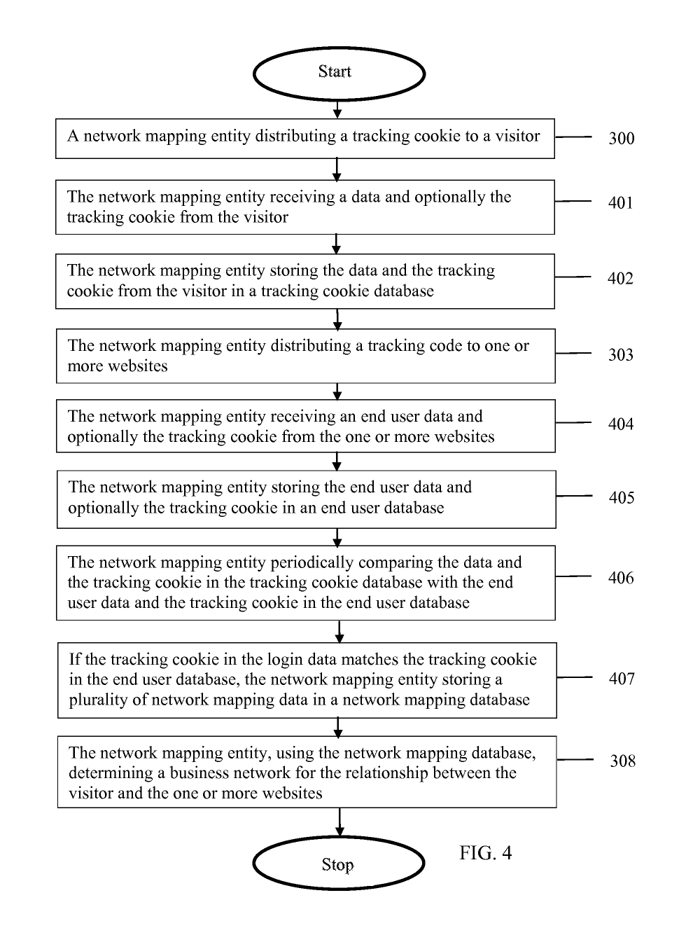

In another embodiment of the invention illustrated in FIG. 4, a method for determining a business network for a plurality of visitors 110, 111, 112 in relation to a plurality of websites 120, 121, 122 engaged in commerce is disclosed. In this embodiment, a network mapping entity 100 (through its front of site, control panels, applications, servers, or websites the network mapping entity 100 directly or indirectly controls) or a tracking cookie distributing website (which may be hosted by the network mapping entity 100) may distribute, i.e. download as is known in the art, a tracking cookie 113 to one or more visitors 111, 112. (Step 300) The network mapping entity 100 may receive data, such as visitor data, customer data, login data, and/or a customized tracking cookie from the visitor's computer 111, 112. (Step 401)

The network mapping entity 100 may store the data from the visitor 111, 112 in a tracking cookie database 101. (Step 402) The network mapping entity 100 may distribute a tracking code 123, 124, 125 to one or more websites 120, 121, 122 engaged in commerce. (Step 303) The network mapping entity 100 may receive an end user data (which may include a customized tracking cookie 113, 114, 115) from the websites 120, 121, 122. (Step 404) The network mapping entity 100 may store the end user data (which may include a tracking cookie 113, 114, 115) in an end user database 102. (Step 405)

The network mapping entity 100 may periodically compare the data in the tracking cookie database 101 with the end user data in the end user database 102. (Step 406) If the visitor, customer, tracking cookie, and/or login data in the tracking cookie database 101 matches the end user data or tracking cookie in the end user database 102, the network mapping entity 100 may store a plurality of network mapping data in a network mapping database 103. (Step 407) Finally, the network mapping entity 100, using the network mapping database 103, may determine a business network for the plurality of visitors and the plurality of websites 120, 121, 122 engaged in commerce. (Step 308)

Other embodiments and uses of the above inventions will be apparent to those having ordinary skill in the art upon consideration of the specification and practice of the inventions disclosed herein. The specification and examples given should be considered exemplary only, and it is contemplated that the appended claims will cover any other such embodiments or modifications as fall within the true scope of the inventions.

The Abstract accompanying this specification is provided to enable the United States Patent and Trademark Office and the public generally to determine quickly from a cursory inspection the nature and gist of the technical disclosure and in no way intended for defining, determining, or limiting the present inventions or any of its embodiments.

The inventions claimed are:

1. A method, comprising the steps of:
a) a network mapping entity receiving an end user data related to a plurality of end users from a plurality of websites engaged in commerce, wherein each of the plurality of websites engaged in commerce uses a tracking code to collect end user data from the plurality of end users; and
b) the network mapping entity using the end user data to determine a business network for the plurality of end users and the plurality of websites engaged in commerce.

2. The method of claim 1, further comprising the step of the network mapping entity or a tracking cookie distributing website distributing a plurality of customized tracking cookies to the plurality of end users.

3. The method of claim 1, further comprising the step of the network mapping entity or a tracking code distributing website distributing a plurality of tracking codes to the plurality of websites engaged in commerce.

4. The method of claim 1, further comprising the step of the network mapping entity or at least one of the plurality of websites engaged in commerce using the determined business network in a targeted marketing campaign.

5. The method of claim 1, further comprising the steps of:
c) the network mapping entity receiving a visitor and customer data for a plurality of visitors and customers of the network mapping entity; and
b) the network mapping entity determining a business network using a machine learning algorithm and the end user data and the visitor and customer data.

6. The method of claim 1, further comprising the step of the network mapping entity providing hosting services for the plurality of websites engaged in commerce.

7. The method of claim 1, wherein the tracking cookie distributing website is hosted by the network mapping entity.

8. A method, comprising the steps of:
a) a network mapping entity or a tracking cookie distributing website distributing a tracking cookie to a plurality of visitors;
b) the network mapping entity receiving a visitor data from at least one of the plurality of visitors;
c) the network mapping entity storing the visitor data from the at least one of the plurality of visitors in a tracking cookie database;
d) the network mapping entity or a tracking code distributing website distributing a tracking code to a plurality of websites engaged in commerce;
e) the network mapping entity receiving an end user data from at least one of the plurality of websites engaged in commerce;
f) the network mapping entity storing the end user data in an end user database; and
g) the network mapping entity determining a business network for the plurality of visitors and the plurality of websites engaged in commerce using a machine learning algorithm and the end user database.

9. The method of claim 8, wherein the tracking cookie distributing website is hosted by the network mapping entity.

10. The method of claim 8, wherein the tracking code distributing website is hosted by the network mapping entity.

11. The method of claim 8, wherein the network mapping entity determines the business network for the plurality of visitors using the end user data and the visitor data.

12. The method of claim 8, further comprising the step of:
h) enhancing a marketing capability of a one or more of the plurality of websites engaged in commerce.

13. The method of claim 8, wherein the tracking cookie database, the end user database, and the network mapping database are part of a centralized database.

14. The method of claim 8, wherein the tracking cookie database, the end user database, and the network mapping database are part of a distributed database.

15. A method, comprising the steps of:
a) a network mapping entity or a tracking cookie distributing website distributing a tracking cookie to a plurality of visitors;
b) the network mapping entity receiving a visitor data from the plurality of visitors;
c) the network mapping entity storing the visitor data from the plurality of visitors in a tracking cookie database;
d) the network mapping entity or a tracking code distributing website distributing a tracking code to a plurality of websites engaged in commerce;
e) the network mapping entity receiving an end user data from at least one of the plurality of websites engaged in commerce;
f) the network mapping entity storing the end user data in an end user database;
g) the network mapping entity periodically comparing the visitor data in the tracking cookie database with the end user data in the end user database;
h) if a first data in the visitor data matches a second data in the end user database, the network mapping entity storing a network mapping data in a network mapping database; and
i) the network mapping entity, using a machine learning algorithm and the network mapping database, determining a business network for the plurality of visitors and the plurality of websites engaged in commerce.

16. The method of claim 15, wherein at least one of the plurality of visitors is a customer of the network mapping entity.

17. The method of claim 15, wherein at least one of the plurality of visitors is an end user of at least one of the plurality of websites engaged in commerce.

18. The method of claim 15, further comprising the step of:
j) the network mapping entity enhancing a marketing capability of a one or more of the plurality of websites engaged in commerce.

19. The method of claim 15, wherein a central database comprises the tracking cookie database, the end user database, and the network mapping database.

20. The method of claim 15, wherein a distributed database comprises the tracking cookie database, the end user database, and the network mapping database.
